(19) United States
(12) Patent Application Publication
(10) Pub. No.: US 2022/0402604 A1
(43) Pub. Date: Dec. 22, 2022

(54) Modular Autonomous Air and Road Vehicle

(71) Applicant: Santh Sathya, Chuluota, FL (US)

(72) Inventor: Santh Sathya, Chuluota, FL (US)

(21) Appl. No.: 17/354,739

(22) Filed: Jun. 22, 2021

(51) Int. Cl. B64C 37/00; B64C 29/00; B60F 5/02

(52) U.S. Cl. CPC B64C 37/00; B64C 29/0033; B60F 5/02; B64C 2211/00

(57) ABSTRACT

The modular autonomous air and road mobility (AARM) vehicle with Vertical Take-off and Landing (VTOL) capability provides combined air and road mobility solution.

AARM is clean energy powered, modular vehicle, which can be undocked and redocked into road module and air module, providing uninterrupted autonomous mobility between air and road. In addition, the modular design enables:
Easy navigation through highly populated areas without the need to accommodate fixed wing aircraft on urban roads.
Reduced energy consumption and noise levels in urban roads by not having to carry the air propulsion system into urban areas.

The road and air modules dock with each other through a sensor guided docking and load carrying mechanism (SGDMS), allowing connectivity, command and control. The vehicle can be scaled appropriately to serve: personal mobility, shared car, air taxis, regional air transport, cargo and shipping, defense missions, medical evacuations and air ambulances.

### BACKGROUND OF THE INVENTION

The invention relates generally to flying Roads, specifically zero emissions electric vertical take-off and landing vehicles and 1) methods for engaging and disengaging the road vehicle from the air vehicle, 2) methods to carry the road vehicle and air vehicle combined system to cruise altitudes, 3) methods to house batteries, fuel cell systems and autonomous navigations and 4) systems integration the road module, air module, fuel systems and control systems.

Today's air mobility solutions mostly focus on just air travel and do not have the integrated ability to travel on road, thereby limiting markets for personal mobility, shared car, last mile cargo delivery and uninterrupted medical rescue and evacuations. They are also limited by the energy density of available battery chemistries. Past efforts in combined road and air vehicle inventions had:
1. Fully integrated design for air and road vehicle, which required added complexity for the wings to be folded or retracted into the vehicle, making the road vehicle bulkier and reducing reliability and endurance.
2. vehicles powered by gas turbines or hybrid gas turbines who are not zero GHG emissions
3. Vehicles which are not vertical take-off and landing types, requiring larger take-off and landing infrastructures, making them incompatible to urban travel.

The future of transportation depends on following factors:
1. Zero emissions propulsion (climate change)
2. Faster travel between cities and within cities (reduced time by 3 times)
3. Reduced urban and highway traffic congestion
4. Vertical Take Off and Landing (VTOL) to conserve space and infrastructure
5. Freedom of personal mobility by seamlessly traveling between cities and within cities.
6. Uninterrupted people transportation in personal, fleet, military, Cargo delivery and rescue missions.

### BRIEF SUMMARY OF THE INVENTION

The modular autonomous air and road mobility (AARM) vehicle with Vertical Take-off and Landing (VTOL) capability provides combined air and road mobility solution.

AARM is clean energy powered, modular vehicle, which can be undocked and redocked into road module and air module, providing uninterrupted autonomous mobility between air and road. In addition, the modular design enables:
Easy navigation through highly populated areas without the need to accommodate fixed wing aircraft on urban roads.
Reduced energy consumption and noise levels in urban roads by not having to carry the air propulsion system into urban areas.

The road and air modules dock with each other through a sensor guided docking and load carrying mechanism (SGDMS), allowing connectivity, command and control. The vehicle can be scaled appropriately to serve markets in personal mobility, shared car, air taxis, regional air transport, cargo and shipping, defense missions, medical evacuations and air ambulances. In addition to modular design and longer cruise distance, the invention is aimed to and disrupt the nascent electric air mobility industry through using a) emerging technologies in light weight fuel cells for aviation, b) high energy density batteries and c) level 4/5 automation

### BRIEF DESCRIPTION OF THE SEVERAL VIEWS OF THE DRAWING

### Abbreviations

AARM—Autonomous Air and Road Mobility

LANC3—Autonomous Navigation, Communication, Command and Control

I-AARM—Interchangeable Autonomous Air and Road Mobility

SGDAMS—Sensor Guided Docking And Mounting System

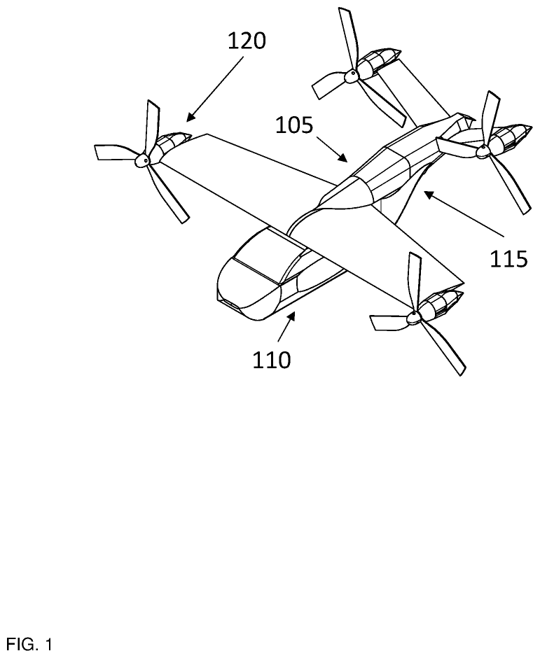

FIG. 1—Isometric view of AARM vehicle in flight mode, showing Road module, air module, four propellers, possible sensor locations and LANC3 location.

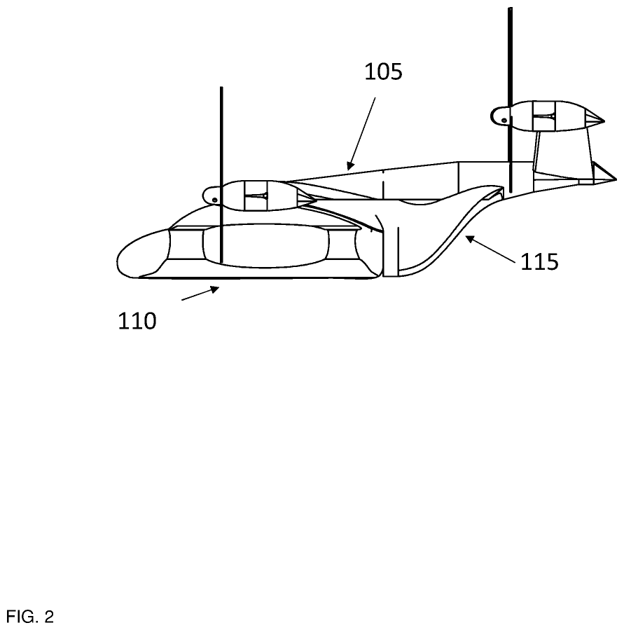

FIG. 2—Side view of AARM vehicle in flight mode

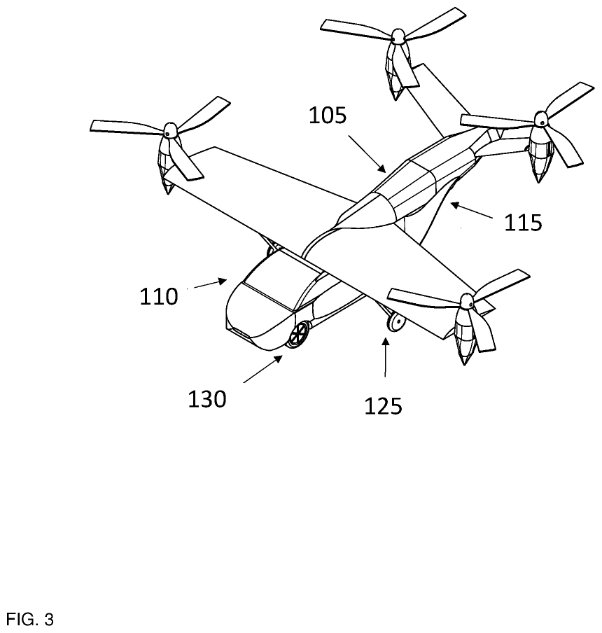

FIG. 3—Isometric view of AARM vehicle in VTOL or landed mode, showing Road module, air module, landing gears for air module and wheels for Road module.

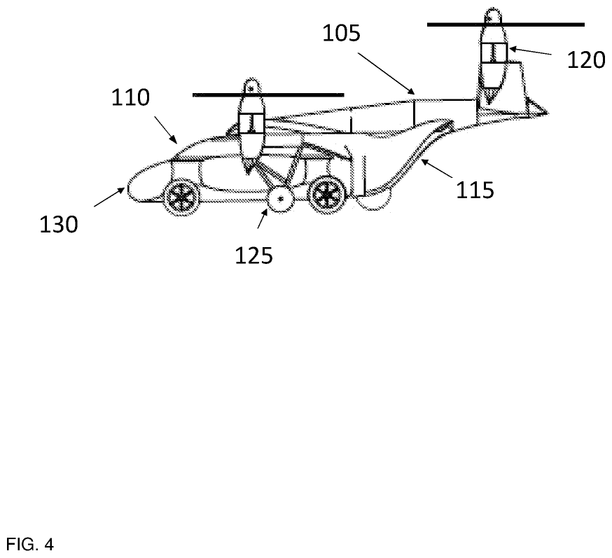

FIG. 4—Side view of AARM vehicle in VTOL or landed mode, showing tilt motors, propellers and z axis.

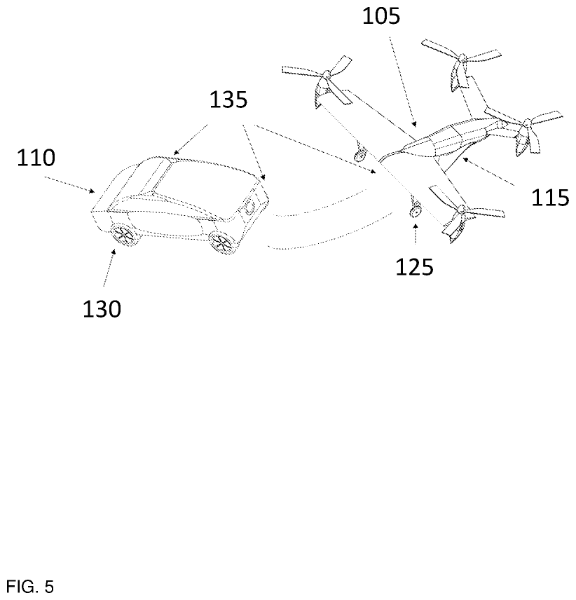

FIG. 5—Isometric view of detachable/detached air module showing H2 fuel cell stack and Storage areas, Sensor Guided Docking and Mounting location.

Isometric view of detachable/detached Road module showing battery storage areas, Sensor Guided Docking and Mounting location.

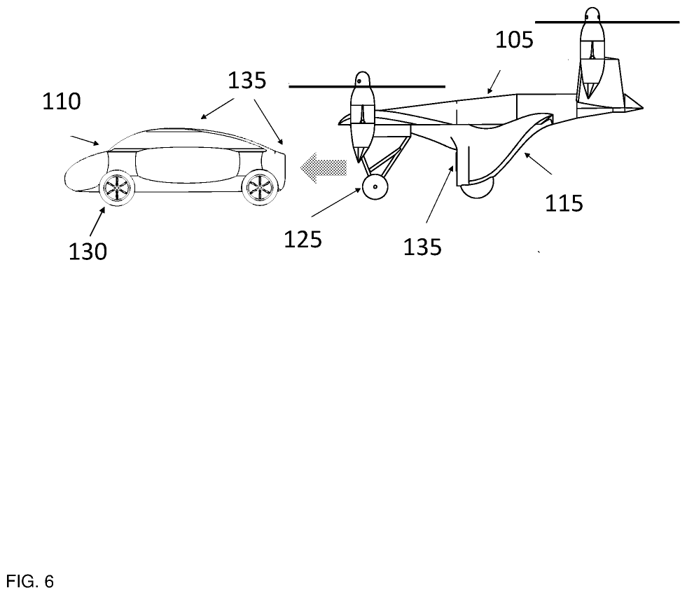

FIG. 6—Side view of detachable/detached air module showing H2 fuel cell stack and Storage areas, Sensor Guided Docking location and landing gears

Side view of detachable/detached Road module showing battery storage areas, Sensor Guided Docking and Mounting location.

### DETAILED DESCRIPTION OF THE INVENTION

AARM Autonomous Air and Road Mobility vehicle, which is H₂ fuel cell and battery powered. It is modular in design and can be disengaged into Road module and air module, providing seamless and uninterrupted autonomous personal mobility between air and road. In addition, the modular design enables:
Reduced congestion and easy navigation through highly populated areas without the need carry the fixed wing aircraft on urban roads.
Reduced energy consumption and noise levels by not having to carry the air propulsion system into urban areas.

The Road module and air module dock with each other through a unique sensor guided docking and load carrying mechanism, allowing connectivity, command and control.

The vehicle and all its components and subcomponents are scalable according to the payload size, gross vehicle weight, cruise distance, cruise altitude, cruise speed, VTOL height and Road mileage requirements.

All components and subcomponents of the AARM are to be manufactured with light weight, high endurance and aero elastic materials like carbon fiber, aluminum alloys and high strength steels etc.,

AARM vehicle consists of:

Air Module (105) II) Road Module (110) III) Sensor guided autonomous docking and mounting system (SGADM) (135) and IV) Autonomous Navigation, Communications, Command and Control System (ANC3)

Each of subsystems, their key components and suggested manufacturing are listed below:

### I) Air Module (105):

### Functions of Air Module (105) are to:

a. vertically take off and land (VTOL) the whole vehicle with its payload into the air, with a vertical climb up to 1000 feet.
b. House h2 fuel cell and storage units or battery systems storage (the power modules 115), whichever is selected to achieved to meet propulsion requirements in terms of vehicle weight and cruise distance.
c. Provide scalable design on propeller blades, packaging spade for fuel cell

The key components of the scalable Air module Air Module (105) are:
1. Fixed wings
2. Three to four propellers to achieve the needed thrust and propulsion to meet performance requirements.
3. Appropriately rated tilt electric motors (120) that articulate along the z axis as the
4. vehicle switches between VTOL mode and flight mode.
5. Other components for electric drive train.
6. Housing space for H2 fuel cells or battery systems (115).
7. Housing for avionics and sensors, LANC3—autonomous navigation, communications, command and control systems.
8. Air module Landing gear (125), with three to four retractable wheels and wheel locking system

### II) Road Module (110):

Functions of the road module (110) are to:
a) Be able to autonomously drive on the road
b) Sense the surroundings, detect objects and navigate safely to destination.
c) Detect stationary and mobile objects in surroundings and avoided collision and
d) House battery systems and electric powertrain (115)
e) Provide scalable design for passengers and cargo transport.
f) Autonomously connect with the Air Module (105) through sensor guided docking system (135).

The key components of the scalable Road module (110) are:
1. Passenger or Cargo compartment that is scalable, based on the application in private mobility, fleet roads or cargo transport or military transport or hospital/first responder transport.
2. Retractable wheels (130) that are used to drive on the road or terrain.
3. Housing for battery systems and electric drivetrain (115)
4. Housing for sensors, autonomous driving systems, LANC3—autonomous navigation, communications, command and control systems.

### III) Sensor Guided Docking and Mounting

### IV) System (LSGDAM):

LSGDS is a NASA style autonomous, sensor guided docking system (135) that is developed by road, which is mounted on both the Road Module (110) and Air Module (105) in locations shown in FIGS. 5 and 6. The guided system is used to dock and mount the Road module (110) to the air module (105) before the flight and to undock after the flight.

### V) Autonomous Navigation Communications, Command and Control (LANC3):

LANC3 has 1) Level 4 (high degree of automation with limited human intervention) and/or Level 5: (complete autonomy, based on the best in class autonomy available), 2) Navigation in GPS and GPS independent environments and 3) V2X (vehicle to everything) connectivity using 5G, with reliability, safety, cyber security and compliance at the core of vehicle operations.

AARM can be built in to two configurations: I) Non Interchangeable and II) interchangeable AARM. The interchangeable AARM configuration is where the air module (105) is interchangeable with any suitable Road module (110) that has the LSGDAM (135) I) Concept of Operations (CONOPS)—non interchangeable AARM

AARM concept of operations for air module (105) and Road module (110) custom manufactured to fit each other is described in below steps:
1. The AARM vehicle vertically lifts off to a certain height
2. With the articulation of the tilt motors (120), the vehicle climbs to cruise height
3. The vehicle descends to VTOL height near destination
4. The vehicle lands vertically at destination.
5. The Road module (110) detaches from the air module (105)
6. The Road module (110) autonomously travels on road to destinations as commanded and returns to dock with the air module (105).
7. The air module (105) can be recharged or refueled with hydrogen depending on the charging/fueling facilities available to the landing location.
8. The air module (105) and Road module (110) dock with each other to complete the AARM
9. The AARM vehicle vertically lifts off for a new destination or return to its original destination.

### II) Concept of Operations—for Interchangeable AARM (I-AARM):

1. The air module (105) docking and mounting system (SGDAM) can be adjusted to match with any road module (110) that needs to be docked.
2. The Road module (110) docks with the air module (105), which is selected based on travel requirements like payload, flight speed, cruise distance etc., A reconfigurable AARM is thus completed.
3. AARM vehicle vertically lifts off to a certain height
4. With the articulation of the tilt motors (120), the vehicle climbs to cruise height
5. The vehicle descends to VTOL height near destination
6. The vehicle lands vertically at destination.
7. The Road module (110) detaches from the air module (105)
8. The Road module (110) autonomously travels on road to destinations as commanded and returns to dock with original air module (105) or a different air module (105), based on the performance need.
9. The air module (105) can dock with a different Road module (110) based on transportation needs like personal mobility, Cargo, defense, healthcare or emergency needs.
10. The air module (105) meanwhile can be recharged or refueled with hydrogen depending on the charging/fueling facilities available to the landing location.
11. The air module (105) and Road module (110) dock with each other to complete a new AARM
12. The AARM vehicle vertically lifts off for a new destination or return to its original destination.

1-4. (canceled)

5: An air and road mobility vehicle system, comprising:
an air module that includes
a main body that houses an internally located avionics suite,
a plurality of wings that extend outward from the main body of the air module,
a plurality of engines, each of the plurality of engines being mounted onto one of the plurality of wings, and
a vehicle docking unit; and
a road module that includes
a main body having an interior space that is configured to receive at least one human occupant,
a plurality of wheels that are retractably engaged to the road module main body,
an electric powertrain that is in communication with the plurality of wheels, and
an airframe docking unit,
wherein the vehicle docking unit and the airframe docking unit include functionality for autonomously docking and undocking the road module and the air module together, and
wherein during a flight, the road module and the air module are in a docked orientation.

6: The system of 5, wherein each of the plurality of motors are configured to tilt between a horizontal orientation and a vertical orientation.

7: The system of claim 6, wherein the plurality of motors are configured to lift the air module and the road module vertically when in the docked orientation.

8: The system of claim 5, wherein each of the wings include a fixed orientation.

9: The system of claim 5, further comprising:
an autonomous driving system that is positioned within the road module.

10: The system of claim 9, wherein the road module is configured to drive autonomously on a road from a first location to a second location.

11: The system of claim 5, wherein the air module is configured to fly autonomously from a first location to a second location.
